(19) United States
(12) Patent Application Publication
(10) Pub. No.: US 2007/0211614 A1
(43) Pub. Date: Sep. 13, 2007

(54) Device and method for manufacturing a master disc using a pulsed write strategy

(75) Inventors: Roger Matheus Josephus Paffen, Eindhoven (NL); Aloysius Michael Josephus Maria Spruijt, Eindhoven (NL); Harmanus Bernardus Bulle, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,935

(22) PCT Filed: Jul. 29, 2005
(86) PCT No.: PCT/IB05/52557

§ 371 Date: Jan. 30, 2007

(30) Foreign Application Priority Data
Aug. 4, 2004 (EP) 04103750.8

(51) Int. Cl. G11B 7/26; B29D 11/00; B29D 17/00

(52) U.S. Cl. 369/275.3; 264/1.33; 264/2.5; 264/1.36

(57) ABSTRACT

The present invention relates to a device for manufacturing a master disc for mastering data on an optical record carrier. To achieve reduced jitter levels resulting from pit widths that are too large, which might result in cross talk effects during read out or even cross write effects during mastering, the application of a pulsed write strategy for manufacturing the master disc is proposed, wherein the pits are recorded by a sequence of a predetermined number of write pulses, said sequence including a number of write pulses having a light intensity of substantially zero.

The present invention relates to a device and a corresponding method for manufacturing a master disc for mastering data on an optical record carrier. The present invention further relates to a device and a corresponding method for manufacturing a record carrier.

In conventional mastering methods, such as for instance disclosed in U.S. Pat. No. 6,026,072, no write strategy is used to create the different effect lengths (that is, the pits) on the master disc. This implies that for a higher energy dose the written effects will become longer and wider after developing. Because of this the pit width may become too large, resulting in cross talk effects during read out of data from an optical record carrier made by use of such a master disc and/or in cross write effects during mastering. These effects can all contribute to undesirable higher jitter levels. Reducing the energy dose in order to avoid these effects is generally not possible since the energy dose might then not be sufficient to write a pit with a sufficient pit depth (or even not sufficient to write a pit at all).

In the European patent application EP 04102470.4 (Mar. 6, 2004; PHNL040596) a method and a device for manufacturing a master disc by use of a write strategy is described. A pit is written by a train (that is, a sequence) of pulses comprising pulses with a pulse width and an intensity at write power level being intersected by periods with a gap width and an intensity at bias power level. Such a train of pulses applied for writing a long pit shows a dogbone like shape where the first and the last pulse have a higher intensity than the pulses in between. This results in the leading and trailing edges of a long pit having a width larger than that of a central pit section between said leading and trailing edges of said pit, which results in a larger modulation.

It is an object of the present invention to provide a device and a corresponding method for manufacturing a master disc by which lower jitter levels are obtained.

This object is achieved according to the present invention by a device for manufacturing a master disc as claimed in claim 1 comprising:

means for applying an exposure light beam modulated in accordance with an information signal representing data to be recorded, thereby forming a train of pits and lands on said master disc, and

means for modulating the intensity of said exposure light beam, wherein a pit is recorded by a sequence of a predetermined number of write pulses, said sequence including write pulses having a light intensity of substantially zero.

A corresponding method for manufacturing a master disc is defined in claim 9. The invention also relates to a device and a corresponding method for manufacturing a record carrier, wherein the device for manufacturing a record carrier comprises a device for manufacturing a master disc as defined above and a means for manufacturing a record carrier by using said master disc.

The invention is based on the idea to apply a pulsed write strategy for manufacturing the master disc, that is, to apply a sequence of a predetermined number of write pulses for writing a pit on the master disc. Furthermore, the intensities of the write pulses of one sequence for writing a pit are all not identical, but a number of write pulses have a light intensity of substantially zero. That is, not all write pulses have a write power level substantial above zero power level or substantial above a bias power level to which the write power is generally reduced in the gaps between the individual write pulses in a sequence (which bias power level shall also be understood as a having a light intensity of “substantially zero”). In this way the pit width and pit length can be well controlled by controlling the position and intensities of the write pulses within a sequence having a light intensity above substantially zero.

Preferred embodiments of the invention are defined in the dependent claims. In a first embodiment the first and second half of a sequence of write pulses have the same number of write pulses with the same sequence of intensities, but in reversed order. The first and second half of the write pulses of a single sequence are thus in mirror symmetrical order, which has the advantage that only a low number of parameters is involved in such a write strategy. In contrast, an asymmetrical writing would require more knowledge of the data written next to the spaces. This could have an advantage when the space size is less then the spot size, i.e. for 2T and 3T lands separating the pits.

In another embodiment the control means are adapted for writing a pit of length nT by use of 2nT write pulses (T being the channel bit period of a channel clock). Thus, a so-called 2T write strategy is applied generally known from recording pits on a phase-change type optical record carrier. In such a write strategy the write pulse length may be chosen to be 0.5T. A pulse length of 0.5T has sufficient resolution while it allows to change the power level at each 0.5 T time period.

In a further preferred embodiment the first and the last write pulse in a sequence have a light intensity of substantially zero. The advantage is that the spaces in the write strategy are increased resulting in a better margin for cross illumination between pits.

Further, in an embodiment of the invention, it is proposed that for writing pits having a length equal to or larger than half the maximum allowed pit length, the first and last two write pulses have a light intensity of substantially zero and the third and fourth write pulses and the third and fourth last write pulses have a substantially maximum light intensity. High power at the first and last pulses increases the steepness of the space to pit and pit to space transition. This improves the transitions in the read out signal. The pit length is thus controlled by the energy dose in the first few pulses and in the last few pulses, while the pit width is controlled by the energy dose in the pulses in between the first few pulses and the last few pulses.

In a further embodiment it is proposed that for writing the longest and the shortest pit the central write pulses in a sequence of write pulses have substantially the largest light intensity in a sequence of write pulses for writing said pits. The more space is in between the write pulses for writing a pit, the higher the write energy must be to minimize the space beyond the detection limit of the read spot. Gaps larger than 1.5T are generally too large to be bridged and an additional write pulse is preferably used in between in order to keep the pit from folding back.

In a further embodiment it is proposed that for writing the shortest pit the central write pulses of a sequence of write pulses have the largest intensity in the sequence of write pulses for writing said shortest pit and/or that for writing the longer pits the central write pulses of the sequence of write pulses have an intensity chosen such as to avoid back folding of the read-out signal in the sequence of write pulses for writing said longer pits. Preferably, the number and the intensities of the write pulses vary depending on the length of the pit to be written. More particularly, for each pit length a predetermined sequence of write pulses, each write pulse having a predetermined intensity, is used.

The invention will now be explained in more detail with reference to the accompanying drawings in which

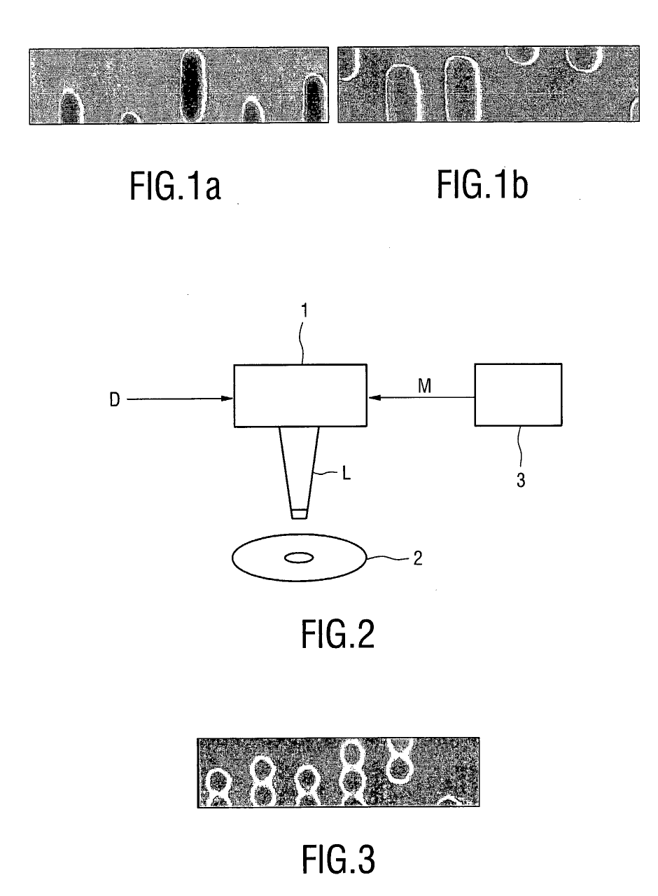

FIG. 1 shows examples of a longer pit written at a low energy dose and at a higher energy dose,

FIG. 2 schematically shows a device for manufacturing a master disc according to the present invention,

FIG. 3 shows a longer pit written by applying a write strategy according to the present invention,

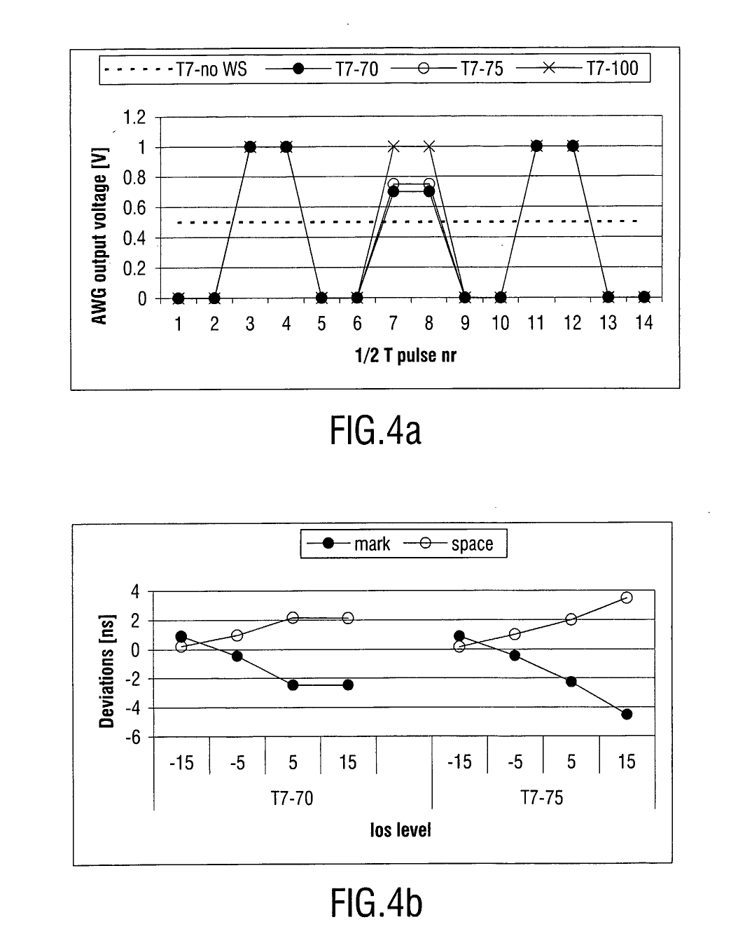

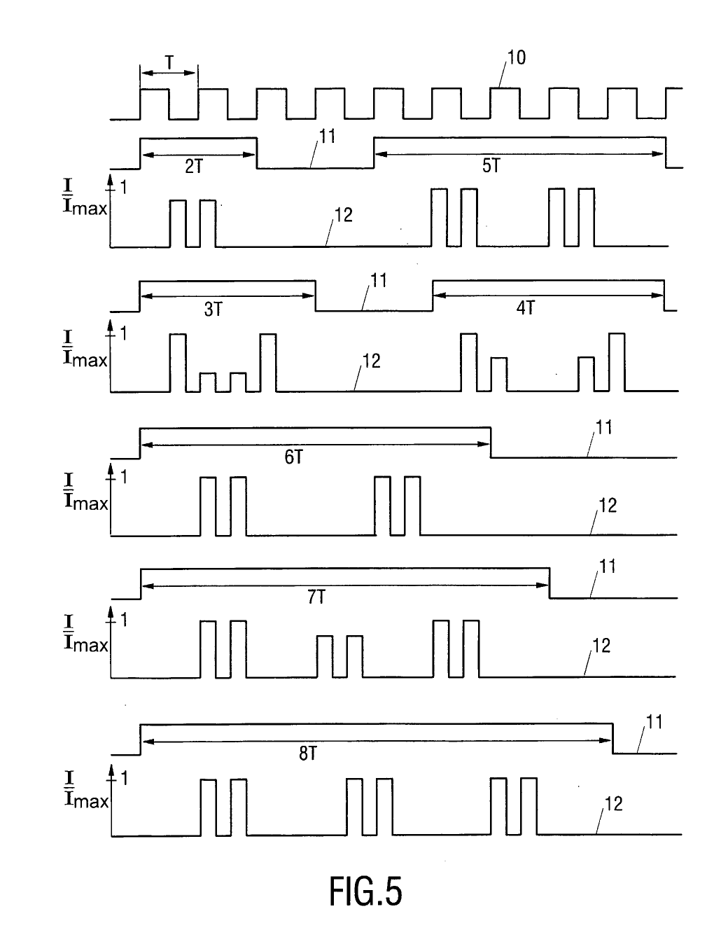

FIG. 4 shows diagrams illustrating the voltage levels of four different T7 writing schemes and the corresponding IOS levels for two T7 writing schemes,

FIG. 5 shows control signals for modulating the intensity of the light beam for writing pits of different lengths,

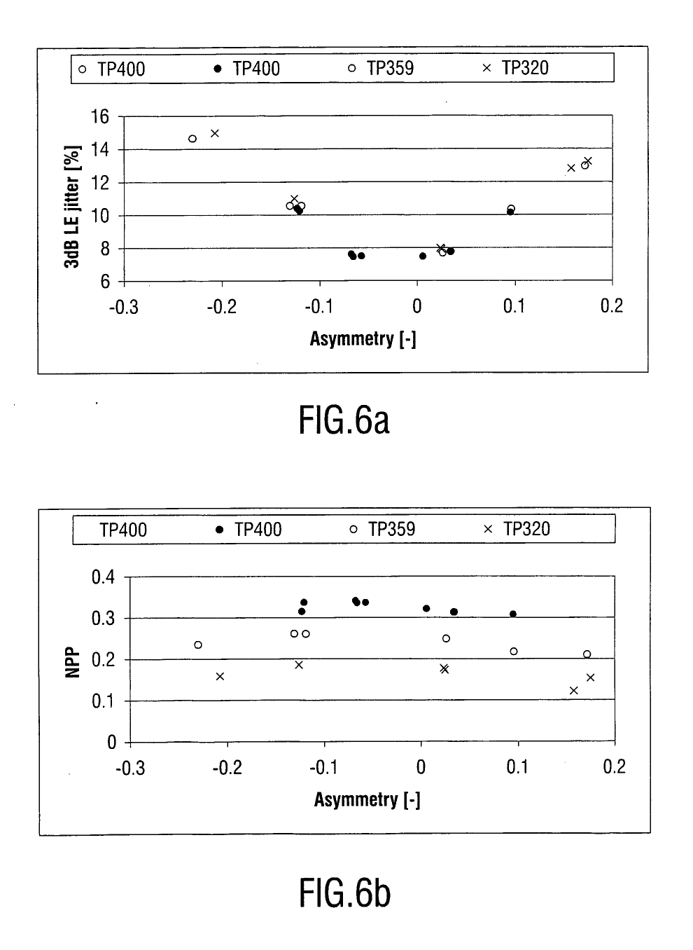

FIG. 6 shows the results of jitter measurements and push pull measurements when applying the write strategy according to the present invention and different track pitches, and

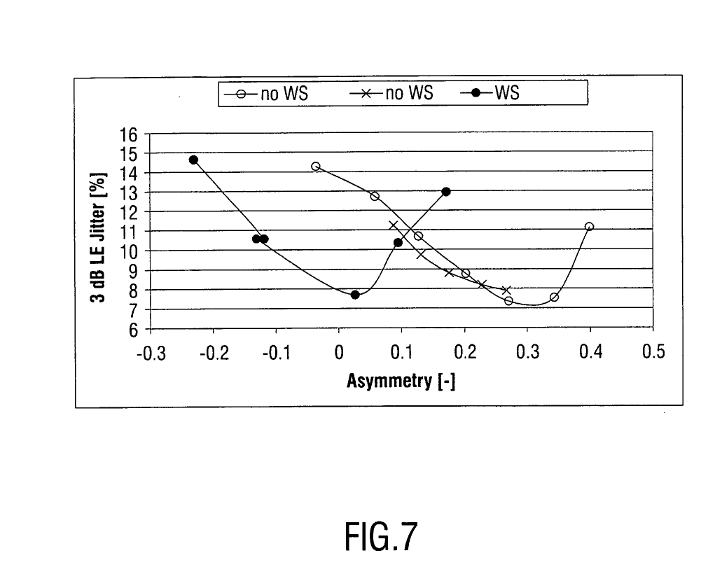

FIG. 7 shows jitter measurements for recordings using the write strategy according to the invention in comparisons to other recordings.

FIG. 1 shows examples of longer pits written by applying a conventional mastering method using no write strategy. The pits shown in FIG. 1a are written at a low energy dose, while the pits shown in FIG. 1b are written at a higher energy dose. As can be seen, the pits are longer and wider when a higher energy dose is used. The pit width can be too large resulting in cross talk effects during read out or even cross write effects during mastering. All these effects contribute to higher jitter levels. This problem is avoided or at least reduced by the present invention.

A schematic block diagram of a device for manufacturing a master disc according to the present invention is shown in FIG. 2. It shows a device 1 for applying an exposure light beam L which is directed to a master disc 2 which is used to record thereon a train of marks (corresponding to the pits) and lands representing data D. The master disc 2 will later be used to manufacture read-only record carriers in a known manner which shall not be described here in more detail. Also shown is a control means 3 for providing a modulation signal M for modulating the intensity of the exposure light beam L according to a write strategy. According to the invention the exposure light beam L is modulated such as to be in the form of a sequence of a predetermined number of write pulses, i.e. a pulsed write strategy is used according to the invention to record marks on the master disc 2. The sequence of said write pulses is in particular provided such that the first and second half of said write pulses show the same intensities (energy doses), but in reversed order. This will be shown and explained in more detail below.

According to the invention the longer pits are created by a pulse train of smaller pits than the effective created pit. The energy dose in the first and last pulse is used to modify the correct pit length, and the energy dose in between these two pulses is used to modify the resulting physical pulse width that corresponds to the effect modulation. A typical image of a longer pit written using a sequence of short write pulses is shown in FIG. 3. In this way the width and the length of a pit can be controlled separately.

As an example four different T7 pits, that is pits having a length of 7T (T being one period of the channel bit clock), will be compared as indicated in the following table:

| | | | | | | | | | | | | | | |
|---|---|---|---|---|---|---|---|---|---|---|---|---|---|---|
| T7-no WS | 0.5 | 0.5 | 0.5 | 0.5 | 0.5 | 0.5 | 0.5 | 0.5 | 0.5 | 0.5 | 0.5 | 0.5 | 0.5 | 0.5 |
| T7-70 | 0 | 0 | 1 | 1 | 0 | 0 | 0.7 | 0.7 | 0 | 0 | 1 | 1 | 0 | 0 |
| T7-75 | 0 | 0 | 1 | 1 | 0 | 0 | 0.75 | 0.75 | 0 | 0 | 1 | 1 | 0 | 0 |
| T7-100 | 0 | 0 | 1 | 1 | 0 | 0 | 1 | 1 | 0 | 0 | 1 | 1 | 0 | 0 |

This table shows that a T7 pit is divided into 14 separate parts, each part of T/2 length. In each T/2 part the AWG (Arbitrary Wave Form Generator) voltage output level corresponding to the energy dose (or intensity) of the exposure light beam, can be adjusted independently.

In the first line the T7 pit is written by applying a continuous write power level of 50% of the maximum power level, i.e. without using a pulsed write strategy (WS). In the next three lines three different write strategies having the same start and ending scheme of 001100 are shown, where only the applied power level of the center pulses differ, i.e. where the applied power level is 70%, 75% or 100% of the maximum power level.

AFM (Atomic force microscope) data show that the T7 pit becomes wider when a more intense center spot is used. More particularly, AFM analysis has shown that a T7-100 written pit is about 58 nm wider compared to a T7-75 pit. From this result an average width increase of about 2 nm for every 1% power increase in the center pulse can be assumed. An example of mark and space length measurements are depicted in FIG. 4. FIG. 4a shows the voltage levels of the four different T7 writing schemes shown in the above table. FIG. 4b shows that T7 mark (or space) length deviations do not differ much when a T7-70 is compared to a T7-75 mark (or space). The T7-75 scheme is thus the preferred writing scheme for a T7 mark. Interpolation of these measurements show a write power at ios=−10 (ios=intensity offset level) at which both the T7 mark and space deviations differ less than 1 ns. Furthermore, a 5% power increase in the center spot does not significantly change the measured deviations. This comparison is used to choose the T7-75 writing scheme for writing a T7 effect.

The above method is applied to all marks to be written from T2 up to T8. The resulting writing scheme is presented in the following table:

| | ½ T | ½ T | ½ T | ½ T | ½ T | ½ T | ½ T | ½ T | ½ T | ½ T | ½ T | ½ T | ½ T | ½ T | ½ T | |
|---|---|---|---|---|---|---|---|---|---|---|---|---|---|---|---|---|
| T2 | | | | | | | 0 | 0.82 | 0.82 | 0 | | | | | | |
| T3 | | | | | | 0 | 1 | 0.33 | 0.33 | 1 | 0 | | | | | |
| T4 | | | | | 0 | 1 | 0.63 | 0 | 0 | 0.63 | 1 | 0 | | | | |
| T5 | | | | 0 | 0 | 1 | 1 | 0 | 0 | 1 | 1 | 0 | 0 | | | |
| T6 | | | 0 | 0 | 1 | 1 | 0 | 0 | 0 | 0 | 1 | 1 | 0 | 0 | | |
| T7 | | 0 | 0 | 1 | 1 | 0 | 0 | 0.75 | 0.75 | 0 | 0 | 1 | 1 | 0 | 0 | |
| T8 | 0 | 0 | 1 | 1 | 0 | 0 | 0 | 1 | 1 | 0 | 0 | 0 | 1 | 1 | 0 | 0 |

This is also illustrated in FIG. 5 showing a clock signal 10 having a clock period of length T. Data signals 11 are shown representing pits (i.e., the high values in the data signals 11) of different length in the range from 2T to 8T. Furthermore, the corresponding control signals 12 are shown applying the write strategy according to the present invention which uses a sequence of write pulses for writing the pits of the different length. As can be seen in each sequence of write pulses, the first and second half of the write pulses for writing a pit of a particular pit length show identical intensities, but in a reversed order. The power levels of the write pulses shown in FIG. 5 correspond to the numbers given in the above table.

This above table shows that a T2 pulse is written by applying four ½ T pulses, a T3 by using six ½ T pulses, and so on. In none of the sequences of write pulses in the above table the first or last ½ T pulse are used (that is, these first and last ½ T pulses have a light intensity of substantially zero). In the sequence for writing 2T pit only the center values remain, which are written at 82% of the maximum writing power. For writing a 3T pit the center ½ T pulses are 33% in between pulses of 100%. For writing a 4T pit the center ½ T pulses are not used. A combination of a 100% and a 63% ½ T pulse is used to start and end the sequence for writing a 4T pit.

The sequence for writing the longer pits (from 5T up to 8T) all are using a 001100 start and ending scheme. The difference between a 5T and a 6T sequence is that the center ‘gap’ is two ½ T pulses long for a 5T pit and four ½ T pulses long for a 6T pit. For a 7T pit the center ½ T pulses are used again, and 75% of the writing power is enough to bridge the large gap between the beginning and the ending of these longer pits. The same holds for an 8T pit where the center ½ T pulses are 100% of the maximum writing power.

Jitter measurements and push pull measurements for recordings using the above-explained writing scheme are shown in FIG. 6. Different track pitches (TP) are used, in particular 320 nm, 359 nm and 400 nm. The results of the jitter measurements (FIG. 6a) show that the low jitter levels of 7.5% can be maintained when the track pitch is decreased from 400 nm to 320 nm. The push pull signal (FIG. 6b) is slightly decreasing down to 0.17 when the track pitch becomes smaller; however, these values are still within, for example, BD-ROM specification.

Finally, FIG. 7 shows jitter measurements from recordings using the above-explained embodiment of the proposed write strategy (WS) compared to other recordings where no write strategy is used (no WS). It can be seen that in recordings where no write strategy is used (no WS) the lowest jitter values can be found outside a range of −0.15 to +0.15 asymmetry. When the write strategy according to the present invention is used low jitter values are maintained; however now at an asymmetry value around 0.

In summary, a pulsed write strategy for mastering is proposed to create both good quality smaller and longer pit shapes. The pit length is controlled by the energy dose in the first few pulses and the last few pulses. The pit width is controlled by the energy dose in the pulses in between these first few and last few pulses. The proposed write strategy is symmetrical in both write pulse position and in write pulse power, whereas known pulsed write strategies for recording on recordable or rewritable media are not symmetrical. The sequences for writing the longer pits use the same starting and ending scheme. By using this method mark and space deviations of approximately 0 ns can be achieved. Cross talk effects in the read-out signal and cross write effects during mastering are minimized by applying the proposed pulsed write strategy.

It is expected that the use of the proposed write strategy can improve the performance of any mastered format. Thus, the present invention is not limited to any particular mastering technology or any particular kind of record carriers, such as CD, DVD or BD.

1. Device for manufacturing a master disc (2) for mastering data on an optical record carrier comprising:
means (1) for applying an exposure light beam (L) modulated in accordance with an information signal (D) representing said data to be recorded, thereby forming a train of marks and lands on said master disc (2), and
control means (3) for modulating the intensity of said exposure light beam, wherein the marks are recorded by a sequence of a predetermined number of write pulses, said sequence including a number of write pulses having a light intensity of substantially zero.

2. Device as claimed in claim 1,
wherein said control means (3) are adapted for writing the marks by a sequence of a predetermined number of write pulses, in which the write pulses in the second half of said sequence of write pulses have the same intensities as the write pulses in the first half of said sequence, but in reversed order.

3. Device as claimed in claim 1,
wherein said control means (3) are adapted for writing a pit of length nT, T being the channel bit period of a channel clock, by use of 2nT write pulses.

4. Device as claimed in claim 3,
wherein the first and last write pulse have a light intensity of substantially zero.

5. Device as claimed in claim 1,
wherein for writing of pits having a length equal to a larger than half the maximum length, the first and last two write pulses have a light intensity of substantially zero and the third and fourth write pulses and the third and fourth last write pulses have substantially maximum light intensity.

6. Device as claimed in claim 1,
wherein for writing the longest and shortest pit the central write pulses of said sequence of write pulses have the largest light intensity in the sequence of write pulses for writing said pit.

7. Device as claimed in claim 1,
wherein for writing the shortest pit the central write pulses of said sequence of write pulses have the largest intensity in the sequence of write pulses for writing said pit.

8. Device for manufacturing a record carrier comprising:
a device for making a master disc as claimed in claim 1, and
means for manufacturing a record carrier by using said master disc.

9. Method for making a master disc (2) for mastering data on an optical record carrier comprising the steps of:
applying an exposure light beam (L) modulated in accordance with an information signal (D) representing said data to be recorded, thereby forming a train of marks and lands on said master disc (2), and
modulating the intensity of said exposure light beam, wherein the pits are recorded by a sequence of a predetermined number of write pulses, said sequence including a number of write pulses having a light intensity of substantially zero.

10. Method for manufacturing a record carrier comprising the steps of:
making a master disc as claimed in claim 1,
manufacturing a record carrier by using said master.
